(19) United States
(12) Patent Application Publication
(10) Pub. No.: US 2006/0215521 A1
(43) Pub. Date: Sep. 28, 2006

(54) Disc drive apparatus

(76) Inventors: Aik Seng Yak, Singapore (SG); Che Chung Pang, Singapore (SG); Wenhua Li, Singapore (SG)

Correspondence Address: PHILIPS INTELLECTUAL PROPERTY & STANDARDS, P.O. BOX 3001, BRIARCLIFF MANOR, NY, 10510, US

(21) Appl. No.: 10/567,044

(22) PCT Filed: Aug. 2, 2004
(86) PCT No.: PCT/IB04/51356

§ 371 Date: Feb. 2, 2006

(30) Foreign Application Priority Data
Aug. 11, 2003 (EP) 03102493.8

(51) Int. Cl. G11B 7/00

(52) U.S. Cl. 369/53.23; 369/44.41

(57) ABSTRACT

A method for controlling an axial position of an objective lens in an optical system of an optical disc drive apparatus, the method comprising the steps of: generating a reference signal (SREF) representing a desired amount of focal error; generating a focal error signal (SFE) representing the actual focal error; generating a focal offset error signal (Sfo) representing the actual focal offset error (FOE); adding the focal offset error signal (SFo) to said reference signal (SREF), and subtracting said focal error signal (SFE), to obtain a result signal (SRES); generating an focal actuator control signal (ScF) on the basis of said result signal (SREs=SREF+SFO. The actual focal offset error (FOE); may be calculated from a lens shift (LS) representing signal on the basis of a predetermined relationship between focal offset error (FOE) and lens shift (IS).

present invention relates in general to a disc drive apparatus for writing/reading information into/from an optical storage disc; hereinafter, such disc drive apparatus will also be indicated as “optical disc drive”.

The present invention relates particularly to an optical disc drive for handling DVD discs, and the invention will be specifically explained for such application. However, it is noted that this is not to be understood as limiting the use of the present invention, as the present invention is useful for other types of disc as well.

As is commonly known, an optical storage disc comprises at least one track, either in the form of a continuous spiral or in the form of multiple concentric circles, of storage space where information may be stored in the form of a data pattern. Optical discs may be read-only type, where information is recorded during manufacturing, which information can only be read by a user. The optical storage disc may also be a writeable type, where information may be stored by a user. For writing information in the storage space of the optical storage disc, or for reading information from the disc, an optical disc drive comprises, on the one hand, rotating means for receiving and rotating an optical disc, and on the other hand an optical system for generating an optical beam, typically a laser beam, and for scanning the storage track with said laser beam. Since the technology of optical discs in general, the way in which information can be stored in an optical disc, and the way in which optical data can be read from an optical disc, is commonly known, it is not necessary here to describe this technology in more detail.

Said optical scanning system comprises a light beam generator device (typically a laser diode), an objective lens for focussing the light beam in a focal spot on the disc, and an optical detector for receiving the reflected light reflected from the disc and for generating an electrical detector output signal.

During operation, the light beam should remain focussed on the disc. To this end, the objective lens is arranged axially displaceable, and the optical disc drive comprises focal actuator means for controlling the axial position of the objective lens. From said detector output signal, a focal error signal can be derived, indicating a focal error, i.e. a measure of the error in the axial position of the objective lens, i.e. the distance between the actual axial position of the objective lens and the desired axial position of the objective lens.

Further, the focal spot should remain aligned with a track or should be capable of being positioned with respect to a new track. To this end, at least the objective lens is mounted radially displaceable, and the optical disc drive comprises radial actuator means for controlling the radial position of the objective lens. From said detector output signal, a radial error signal can be derived, indicating a radial error, i.e. a measure of the error in the radial position of the focal spot, i.e. the distance between the centre of the focal spot and the centre of the track.

More particularly, the optical disc drive comprises a sledge which is displaceably guided with respect to a disc drive frame, intended for roughly positioning the optical lens. For fine-tuning the position of the optical lens, the objective lens is displaceably mounted with respect to said sledge. The displacement range of the objective lens with respect to the sledge is relatively small, but the positioning accuracy of the objective lens with respect to the sledge is larger than the positioning accuracy of the sledge with respect to the frame.

On the other hand, other optical components of the optical system, such as the beam generator, the optical detector, etc, which define the location of the optical axis of the light beam path, are mounted to the frame or to the sledge. This means that, when the objective lens is displaced radially in order to follow a track, i.e. displaced in a direction perpendicular to the optical axis of the light beam, the optical axis of the objective lens is displaced with respect to the optical axis of the light beam. Hereinafter, the distance between optical axis of the objective lens and optical axis of the light beam will be termed “lens shift”.

As a consequence of off-centre distance, an error is introduced into the radial error signal and the focal error signal. In other words, if the focal error signal is processed to calculate the focal error and thus to calculate the distance from the current axial position to the desired axial position of the objective lens, the calculated result is not correct. If the focal error signal indicates a focal error zero, the objective lens will actually be “off-focus”, i.e. there is still a distance between desired axial position and actual axial position; this distance will hereinafter be termed “focal offset error”.

Similarly, if the radial error signal indicates a radial error zero, there is still a distance between the centre of the beam and the centre of the track: this distance will hereinafter be termed “radial offset error”.

These offset errors increase with increasing lens shift. Since these offset errors are acceptable only up to a certain extent, a limitation is put to the amount of lens shift which can be used in tracking. This useable amount of lens shift will hereinafter be termed “tracking range”.

In an optical system, the objective lens can be of infinite conjugate type or of finite conjugate type. Conventional optical systems comprise an infinite conjugate objective lens, but it is desirable to use a finite conjugate objective lens for reason of reduced costs because of reduced number of components. A problem with finite conjugate objective lenses is, however, the fact that the offset errors are larger as compared to infinite conjugate objective lenses. As a consequence, the tracking range of finite conjugate objective lenses is smaller than the tracking range of infinite conjugate objective lenses.

It is a general objective of the present invention to eliminate or at least reduce these problems.

Specifically, the present invention aims to provide a method and device in which the offset errors are reduced.

More specifically, the present invention aims to provide a method and device in which the tracking range is increased.

More specifically, the present invention aims to provide a compensation method for an optical disc drive comprising a finite conjugate objective lens such that the tracking range is comparable to the tracking range of an optical disc drive comprising an infinite conjugate objective lens in which the compensation method is not implemented.

According to an important aspect of the invention, a relationship between offset error and lens shift is determined; the current lens shift is determined; the current offset error is determined from the current lens shift on the basis of said relationship; and this offset error is used to compensate the focal error signal and/or the radial error signal, respectively.

In principle, it is possible to actually measure the lens shift by any suitable measuring device, and to use the measuring result in the compensation process. This is, however, not preferred, because it involves an additional measuring device and hence additional costs. In a preferred embodiment, a lens shift indicating signal is derived from the optical detector output signal, which can be implemented relatively easily by a suitable software processing of the optical detector output signal, although a hardware implementation is also feasible.

These and other aspects, features and advantages of the present invention will be further explained by the following description with reference to the drawings, in which same reference numerals indicate same or similar parts, and in which:

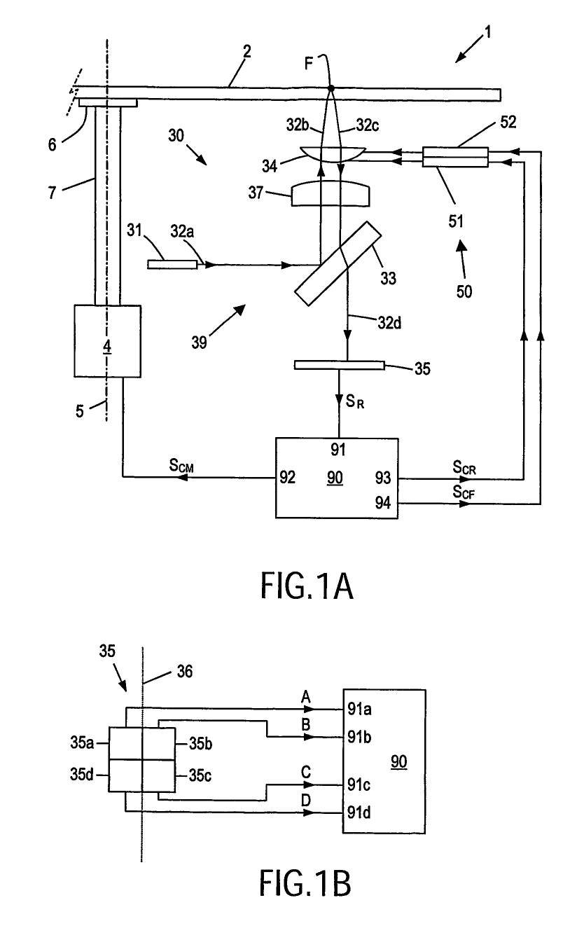

FIG. 1A schematically illustrates relevant components of an optical disc drive apparatus;

FIG. 1B schematically illustrates an optical detector;

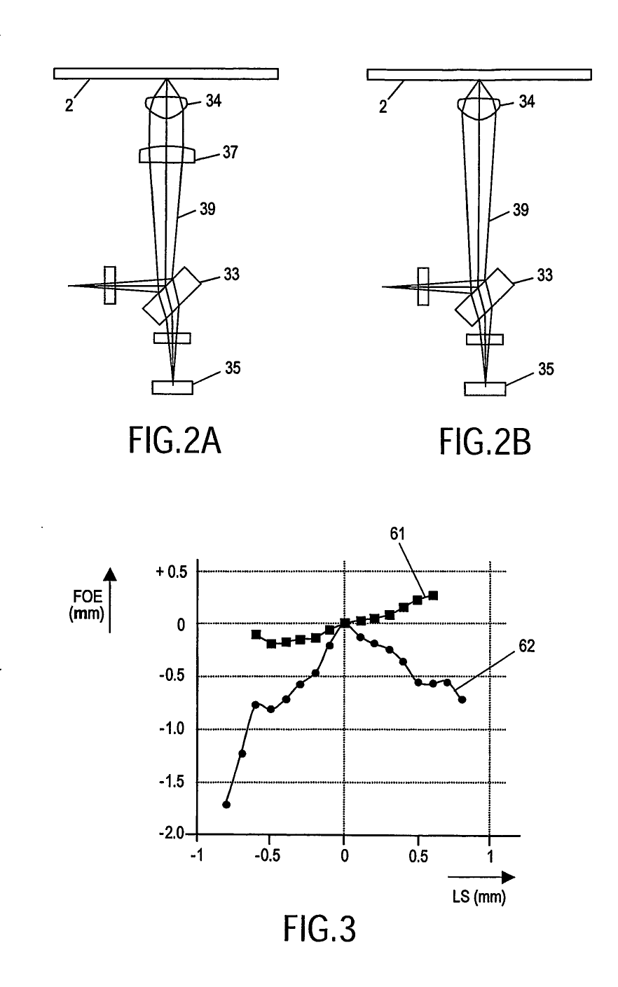

FIG. 2A schematically illustrates the optical path of an infinite conjugate lens configuration;

FIG. 2B schematically illustrates the optical path of a finite conjugate lens configuration;

FIG. 3 is a graph showing a relationship between lens shift and focal offset error;

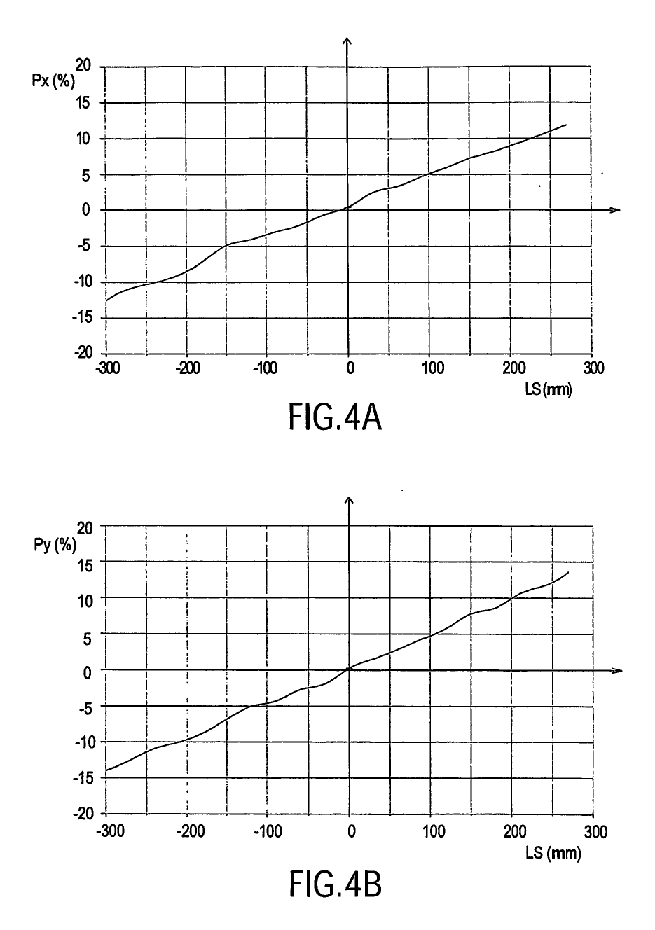

FIGS. 4A and 4B are graphs illustrating signals Px and Py as a function of lens shift;

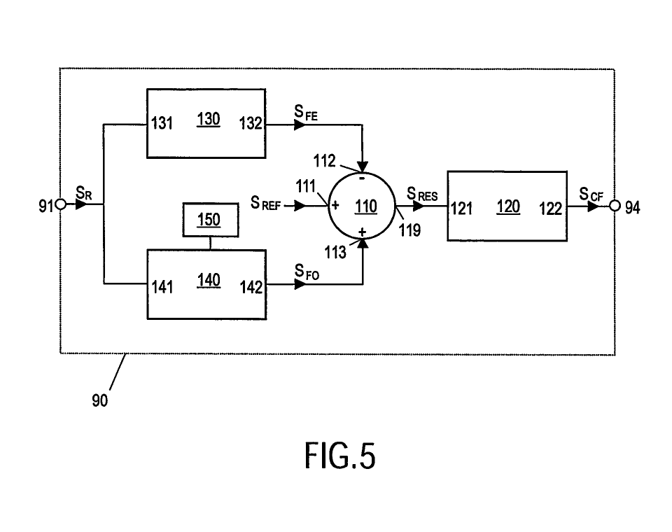

FIG. 5 is a block diagram illustrating details of a controller.

FIG. 1A schematically illustrates an optical disc drive apparatus 1, suitable for storing information on or reading information from an optical disc 2, typically a DVD or a CD. For rotating the disc 2, the disc drive apparatus 1 comprises a motor 4 fixed to a frame (not shown for sake of simplicity), defining a rotation axis 5.

The disc drive apparatus 1 further comprises an optical system 30 for scanning tracks (not shown) of the disc 2 by an optical beam. More specifically, in the exemplary arrangement illustrated in FIG. 1A, the optical system 30 comprises a light beam generating means 31, typically a laser such as a laser diode, arranged to generate a light beam 32. In the following, different sections of the light beam 32, following an optical path 39, will be indicated by a character a, b, c, etc added to the reference numeral 32.

The light beam 32 passes a beam splitter 33, a collimator lens 37 and an objective lens 34 to reach (beam 32b) the disc 2. The light beam 32b reflects from the disc 2 (reflected light beam 32c) and passes the objective lens 34, the collimator lens 37 and the beam splitter 33 (beam 32d) to reach an optical detector 35. The objective lens 34 is designed to focus the light beam 32b in a focal spot F on a recording layer (not shown for sake of simplicity) of the disc.

The disc drive apparatus 1 further comprises an actuator system 50, which comprises a radial actuator 51 for radially displacing the objective lens 34 with respect to the disc 2. Since radial actuators are known per se, while the present invention does not relate to the design and functioning of such radial actuator, it is not necessary here to discuss the design and functioning of a radial actuator in great detail.

For achieving and maintaining a correct focusing, exactly on the desired location of the disc 2, said objective lens 34 is mounted axially displaceable, while further the actuator system 50 also comprises a focal actuator 52 arranged for axially displacing the objective lens 34 with respect to the disc 2. Since axial actuators are known per se, while further the design and operation of such axial actuator is no subject of the present invention, it is not necessary here to discuss the design and operation of such focal actuator in great detail.

It is further noted that means for supporting the objective lens with respect to an apparatus frame, and means for axially and radially displacing the objective lens, are generally known per se. Since the design and operation of such supporting and displacing means are no subject of the present invention, it is not necessary here to discuss their design and operation in great detail.

It is further noted that the radial actuator 51 and focal actuator 52 may be implemented as one integrated actuator.

The disc drive apparatus 1 further comprises a control circuit 90 having a first output 92 connected to a control input of the motor 4, having a second output 93 coupled to a control input of the radial actuator 51, and having a third output 94 coupled to a control input of the focal actuator 52. The control circuit 90 is designed to generate at its first output 92 a control signal S_{CM} for controlling the motor 4, to generate at its second control output 93 a control signal S_{CR} for controlling the radial actuator 51, and to generate at its third output 94 a control signal S_{CF} for controlling the focal actuator 52.

The control circuit 90 further has a read signal input 91 for receiving a read signal SR from the optical detector 35.

FIG. 1B illustrates that the optical detector 35 comprises a plurality of detector segments, in this case four detector segments 35a, 35b, 35c, 35d, capable of providing individual detector signals A, B, C, D, respectively, indicating the amount of light incident on each of the four detector quadrants, respectively. A centre line 36, separating the first and fourth segments 35a and 35d from the second and third segments 35b and 35c, has a direction corresponding to the track direction. Since such four-quadrant detector is commonly known per se, it is not necessary here to give a more detailed description of its design and functioning.

FIG. 1B also illustrates that the read signal input 91 of the control circuit 90 actually comprises four inputs 91a, 91b, 91c, 91d for receiving said individual detector signals A, B, C, D, respectively. The control circuit 90 is designed to process said individual detector signals A, B, C, D, in order to derive data and control information therefrom, as will be clear to a person skilled in the art.

In the optical system 30 as illustrated in FIG. 1A, the optical beam 32 has parallel rays in the part of the light path 39 between objective lens 34 and collimator lens 37. In such a design, the objective lens 34 is termed “infinite conjugate”. The optical path 39 of such infinite conjugate configuration is shown in more detail in FIG. 2A. FIG. 2B is a figure comparable to FIG. 2A, illustrating the optical path 39 of an optical system of finite conjugate configuration, in which case the optical rays leaving the objective lens 34 are always converging. Because of the absence of the collimator lens 37, the optical system of finite conjugate configuration, illustrated in FIG. 2B, is less costly.

As mentioned before, the objective lens 34 can be displaced radially with respect to the optical beam path 39. This lens shift also indicated as LS, causes an offset error in the focal error signal and an offset error in the radial error signal. FIG. 3 is a graph showing the results of a measurement of the focal offset error FOE (in μm) as a function of the lens shift LS (in mm) for the case of an infinite conjugate lens (curve 61) and for the case of a finite conjugate lens (curve 62).

It can clearly be seen from this graph that, at a certain lens shift, the focal offset error in the case of a finite conjugate lens is much larger than in the case of an infinite conjugate lens.

Further, it can clearly be seen from this graph that the tracking range in the case of a finite conjugate lens is much smaller than in the case of an infinite conjugate lens. Assume that a focal offset error of 0.25 μm would be acceptable: then the tracking range in the case of an infinite conjugate lens would be more than 0.5 mm, while in the case of a finite conjugate lens the tracking range would be approximately −0.1 and +0.3 mm.

As already mentioned, the control circuit 90 is designed to process said individual detector signals A, B, C, D, in order to derive data and control information therefrom. For instance, a data signal S_{D} can be obtained by summation of all individual detector signals A, B, C, D according to
S_{D}=A+B+C+D (1)

Further, signals Px and Py can be defined according to

$$\begin{matrix}Px = LP ( \frac{( A + B ) - ( C + D )}{A + B + C + D} ) & ( 2 ) \\ Py = LP ( \frac{( B + C ) - ( A + D )}{A + B + C + D} ) & ( 3 )\end{matrix}$$

Herein, the function LP(x) represents a low-pass filtering of signal x. The precise filter characteristics are not critical, but the cut-off frequency is preferably chosen as low as possible, so that signals Px and Py may be considered as substantially being DC signals.

These signals Px and Py also appear to depend on lens shift, as illustrated in FIGS. 4A and 4B. FIG. 4A is a graph showing results of a simulation with a representative specimen of a DVD disc drive having an optical pickup unit with a finite conjugate objective lens, the graph showing Px as a function of lens shift in the tracking direction, i.e. corresponding to a direction perpendicular to the direction of the tracks. FIG. 4B is a graph similar to FIG. 4A, showing Py as a function of lens shift in the tracking direction.

It can clearly be seen from FIGS. 4A and 4B that the signals Px and Py depend strongly on the lens shift. Therefore, these signals are capable of being used as measuring signal representing lens shift.

FIG. 5 is a block diagram, schematically illustrating part of the operation of the controller 90 for compensating for focal offset, on the basis of said signals Px and Py. The controller 90 comprises an adder 110, having a first input 111 and a second input 112, and an output 119. The first input 111 is a non-inverting input, the second input 112 is an inverting input. At its first input 111, the adder 110 receives a reference signal S_{REF}, which may have a fixed value or a user-settable value. This reference signal indicates the desired amount of focal error. Usually, this is zero, but there may be situations where a certain non-zero focal error is better to compensate a focal error which may develop, inside the optical pickup or outside, due to for instance temperature. The output 119 of the adder 110 is coupled to an input 121 of a control block 120, for instance a PID control block, which generates the control output signal S_{CF} for the focal actuator 52 at its output 122.

The focal actuator 52 sets the axial position of the objective lens 34, which influences the light beam 32d as received by the optical detector 35, which generates the output signal S_{R}, as already described. The output signal S_{R} from the optical detector 35 is received by the controller 90 at its input 91.

The controller 90 comprises a first processing block 130, having an input 131 coupled to the input 91 of the controller 90, and having an output 132 coupled to the second input 112 of the adder 110. The first processing block 130 is designed for calculating the actual focal error on the basis of the detector output signal S_{R}, and for generating a focal error signal S_{FE} representing the actual focal error, as will be known to a person skilled in the art.

If the adder 110 only receives the signals S_{REF} and S_{FE} at its first and second inputs, respectively, the adder output signal S_{RES} and hence the focal actuator control signal S_{CF} would represent the difference between the actual focal error and the desired amount of focal error, displacing the objective lens to reduce this difference. If the actual focal error is equal to the desired amount of focal error, the output signal S_{RES} of adder 110 would be zero, and the focal actuator control signal S_{CF} would not cause any further displacement of the objective lens 34.

The above description of the controller 90 may be considered as a description of the functioning of the prior art. It works fine, as long as the objective lens 34 is aligned with the optical bean 32. However, if a lens shift occurs, a focal offset error occurs. As a consequence, the output signal S_{FE} from the first processing block 130 does not correspond to the actual focal error any more. If, in this situation, the objective lens 34 is brought to a position where the output signal S_{FE} from the first processing block 130 is equal to the reference signal S_{REF}, so that the output signal S_{RES} of adder 110 would be zero, the actual focal error is actually not equal to the desired focal error.

According to the present invention, this problem is overcome by a second processing block 140, having an input 141 coupled to the input 91 of the controller 90, and having an output 142 coupled to a third input 113 of the adder 110, which is a non-inverting input. The second processing block 140 is designed for calculating the focal offset caused by the lens shift, and for generating a focal offset signal S_{FO} representing the focal offset. This focal offset signal S_{FO} is added to the reference signal S_{REF}, so that the focal offset is compensated in the resulting output signal S_{RES} from the adder 110, which can be written as
S_{RES}=S_{REF}+S_{FO}−S_{FE}

In this situation, the output signal S_{FE} from the first processing block 130 still does not correspond to the actual focal error, but the difference is compensated by the focal offset signal S_{FO}.

In a possible embodiment, the second processing block 140 is associated with a measuring device for measuring the lens shift. In the preferred embodiment, the second processing block 140 is designed for calculating the focal offset on the basis of the detector output signal S_{R} received at controller input 91. In a possible embodiment, the second processing block 140 is designed for calculating the signal Px or Py from the detector output signal S_{R}, using formula (2) or (3), respectively, and for determining the lens shift on the basis of a first predetermined relationship between lens shift and the signal Px or Py, respectively, as illustrated in FIG. 4A or 4B, respectively. This first predetermined relationship, which may be obtained through measurement or simulation, may be stored in a memory 150 associated with the second processing block 140, for instance as a formula or a look-up table, as will be clear to a person skilled in the art. The information regarding said first predetermined relationship may be stored in said memory 150 by the manufacturer of the disc drive apparatus.

Then, knowing the lens shift, the second processing block 140 may calculate the focal offset signal S_{FO} on the basis of a second predetermined relationship between lens shift and the focal offset, as illustrated in FIG. 3. This second predetermined relationship, which may also be obtained through measurement or simulation, may also be stored in said memory 150, for instance as a formula or a look-up table.

In the above example, the calculation of the focal offset signal S_{FO} is a two-step process: firstly, lens shift is determined, then, focal offset is determined. However, it is not necessary to actually calculate the lens shift. Said first and second predetermined relationships may be combined into a direct predetermined relationship between the focal offset and the signal Px or Py, respectively, which direct predetermined relationship may be stored in said memory 150, for instance as a formula or a look-up table. Thus, in a preferred embodiment, the second processing block 140 is designed to determine the signal Px or Py, respectively, and to determine the focal offset on the basis of said direct predetermined relationship stored in said memory 150.

It is possible that the focal offset signal S_{FO} is calculated on the basis of Px only, or on the basis of Py only. The choice whether to use Px or Py may be left to the designer of the controller 90. However, it is also possible to use Px and Py in combination when calculating the focal offset signal S_{FO}. An advantage of using Px and Py in combination would be a reduction of effects of possible drifts in Px and Py due to other mechanical problems.

A parameter Pz being a function of Px and Py will hereinafter be indicated as Pz(Px,Py). The relationship between Pz and lens shift LS can simply be obtained from combining the graphs of FIGS. 4A and 4B in accordance with the function as defined, as will be clear to a person skilled in the art. Pz should be chosen such that the relationship between Pz and lens shift LS is a one-to-one relationship. In an exemplary embodiment, this parameter Pz is defined according to
Pz(Px,Py)=Px+Py (4)

It is noted that the signals Px and Py themselves may contain initial errors, which can be corrected by calibration. In a calibration procedure, the objective lens 34 is brought to a position of which it is determined that the lens shift LS is zero. Then, the signals Px and Py are measured; their measured values will be indicated as Px₀ and Py₀, respectively. These values are taken as zero-values, so that in later processing at time t, when the signals Px and Py are measured to have measured values indicated as Px(t) and Py(t), respectively, corrected values Px′(t) and Py′(t), respectively, are calculated as
Px′(t)=Px(t)−Px₀ (5a)
Py′(t)=Py(t)−Py₀ (5b)

Thus, the present invention succeeds in providing a method and apparatus for controlling an axial position of an objective lens in an optical system of an optical disc drive apparatus, wherein a focal offset error is compensated. The compensation is calculated by processing a signal which indicates lens shift, on the basis of the insight that a relationship exists between lens shift and focal offset error. Such signal which indicates lens shift can be a signal derivable from the output signal from the optical detector, on the basis of the insight that a relationship exists between lens shift and the optical detector output signal.

It should be clear to a person skilled in the art that the present invention is not limited to the exemplary embodiments discussed above, but that several variations and modifications are possible within the protective scope of the invention as defined in the appending claims.

For instance, with reference to FIG. 5, a controller is described for compensating for focal offset, which needs a measuring signal indicative for lens shift. In principle, another measuring method may be used, and the described method, which is preferred, is not intended to restrict the scope of the invention.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, etc.

1. Method for determining lens shift (LS) in an optical system (30) of an optical disc drive apparatus (1), the optical system (30) comprising:
beam generator means (31) for directing a light beam (32) towards an optical disc (2);
an optical detector (35) for receiving a reflected light beam (32d) and for generating an detector output signal (S_{R});
the method comprising the steps of:
determining a relationship between lens shift (LS) and at least one signal component (Px;Py) derivable from the detector output signal (S_{R});
processing the actual detector output signal (S_{R}) to calculate said at least one signal component (Px;Py);
calculating actual lens shift (LS) from said at least one signal component (Px;Py) on the basis of said relationship.

2. Method according to claim 1, wherein the optical detector (35) is designed to generate detector output signals (A, B, C, D) representing the detected amount of light in four quadrants (35a, 35b, 35c, 35d), and wherein said at least one signal component (Px) is defined according to
$$Px = LP ( \frac{( A + B ) - ( C + D )}{A + B + C + D} ) \qquad ( 2 )$$
wherein LP( ) indicates a low-pass filtering.

3. Method according to claim 1, wherein the optical detector (35) is designed to generate detector output signals (A, B, C, D) representing the detected amount of light in four quadrants (35a, 35b, 35c, 35d), and wherein said at least one signal component (Py) is defined according to
$$Py = LP ( \frac{( B + C ) - ( A + D )}{A + B + C + D} ) \qquad ( 3 )$$
wherein LP( ) indicates a low-pass filtering.

4. Method according to claim 1, wherein information regarding said relationship is read from a memory (150).

5. Method for determining focal offset error (FOE) in an optical system (30) of an optical disc drive apparatus (1), the optical system (30) comprising:
beam generator means (31) for directing a light beam (32) towards an optical disc (2);
an optical detector (35) for receiving a reflected light beam (32d) and for generating an detector output signal (S_{R});
an objective lens (34) arranged for focussing the light beam (32b) in a focal spot (F) on an information layer of the disc (2), the objective lens (34) being displaceable in a direction perpendicular to the optical axis of the light beam (32);
the method comprising the steps of:
detecting a signal representative for the actual lens shift (LS);
calculating the actual focal offset error (FOE) from said lens shift (LS) representing signal on the basis of a predetermined relationship between focal offset error (FOE) and lens shift (LS).

6. Method according to claim 5, wherein said lens shift (LS) representing signal is derived from the detector output signal (S_{R}).

7. Method according to claim 5, wherein information regarding said relationship is read from a memory (150).

8. Method according to claim 5, wherein lens shift (LS) is determined in accordance with the method of claim 1.

9. Method for determining focal offset error (FOE) in an optical system (30) of an optical disc drive apparatus (1), the optical system (30) comprising:
beam generator means (31) for directing a light beam (32) towards an optical disc (2);
an optical detector (35) for receiving a reflected light beam (32d) and for generating an detector output signal (S_{R});
an objective lens (34) arranged for focussing the light beam (32b) in a focal spot (F) on an information layer of the disc (2), the objective lens (34) being displaceable in a direction perpendicular to the optical axis of the light beam (32);
the method comprising the steps of:
determining a direct relationship between focal offset error (FOE) and at least one signal component (Px;Py) derivable from the detector output signal (S_{R});
processing the actual detector output signal (S_{R}) to calculate said at least one signal component (Px;Py);
calculating actual lens shift (LS) from said at least one signal component (Px;Py) on the basis of said direct relationship.

10. Method according to claim 9, wherein the optical detector (35) is designed to generate detector output signals (A, B, C, D) representing the detected amount of light in four quadrants (35a, 35b, 35c, 35d), and wherein said at least one signal component (Px) is defined according to
$$Px = LP ( \frac{( A + B ) - ( C + D )}{A + B + C + D} ) \qquad ( 2 )$$
wherein LP( ) indicates a low-pass filtering.

11. Method according to claim 9, wherein the optical detector (35) is designed to generate detector output signals (A, B, C, D) representing the detected amount of light in four quadrants (35a, 35b, 35c, 35d), and wherein said at least one signal component (Py) is defined according to
$$Py = LP ( \frac{( B + C ) - ( A + D )}{A + B + C + D} ) \qquad ( 3 )$$
wherein LP( ) indicates a low-pass filtering.

12. Method for controlling an axial position of an objective lens (34) in an optical system (30) of an optical disc drive apparatus (1), the optical system (30) further comprising:
beam generator means (31) for directing a light beam (32) towards an optical disc (2);
an optical detector (35) for receiving a reflected light beam (32d) and for generating an detector output signal (S_{R});
the objective lens (34) being arranged for focussing the light beam (32b) in a focal spot (F) on an information layer of the disc (2), the objective lens (34) being displaceable in a direction perpendicular to the optical axis of the light bema (32);
the method comprising the steps of:
generating a reference signal (S_{REF}) representing a desired amount of focal error;
generating a focal error signal (S_{FE}) representing the actual focal error;
generating a focal offset error signal (S_{FO}) representing the actual focal offset error (FOE);
adding the focal offset error signal (S_{FO}) to said reference signal (S_{REF}), and subtracting said focal error signal (S_{FE}), to obtain a result signal (S_{RES});
generating an focal actuator control signal (S_{CF}) on the basis of said result signal (S_{RES}=S_{REF}+S_{FO}−S_{FE}).

13. Method according to claim 12, wherein said focal offset error signal (S_{FO}) is determined in accordance with claim 5.

14. Method according to claim 12, wherein said focal offset error signal (S_{FO}) is determined in accordance with claim 9.

15. Optical disc drive apparatus (1) for reading information from an optical disc (2) or writing information to an optical disc (2), comprising:
beam generator means (31) for directing a light beam (32) towards the optical disc (2);
an optical detector (35) for receiving a reflected light beam (32d) and for generating an detector output signal (S_{R});
an objective lens (34) being arranged for focussing the light beam (32b) in a focal spot (F) on an information layer of the disc (2), the objective lens (34) being displaceable in a direction perpendicular to the optical axis of the light beam (32), the objective lens (34) further being displaceable in a direction parallel to the optical axis of the light beam (32);
a focal actuator (52) for setting the axial position of the objective lens (34);
a control circuit (90) for generating a control signal (S_{CF}) for controlling the focal actuator (52);
wherein the control circuit (90) is designed to perform the method of claim 12.

16. Optical disc drive apparatus (1) according to claim 15, wherein the control circuit (90) comprises:
an input (91) for receiving the detector output signal (S_{R});
a first processing block (130) for processing the detector output signal (S_{R}) to calculate a focal error signal (S_{FE});
a second processing block (140) for calculating a focal offset signal (S_{FO});
means (110) for adding the focal offset signal (S_{FO}) to and subtracting the focal error signal (S_{FE}) from a reference signal (S_{RE}) and generating a result signal (S_{RES});
means for generating an actuator control signal (S_{CF}) on the basis of said result signal (S_{RES}).

17. Optical disc drive apparatus (1) according to claim 16, wherein the control circuit (90) further comprises a memory (150) containing information on a relationship between the focal offset signal (S_{FO}) and at least one measuring signal (Px;Py) derivable from the detector output signal (S_{R}).

18. Optical disc drive apparatus (1) according to claim 16, wherein the second processing block (140) is designed for processing the detector output signal (S_{R}) to derive said at least one measuring signal (Px;Py) from the detector output signal (S_{R}), and to calculate the focal offset signal (S_{FO}) from said at least one measuring signal (Px;Py) on the basis of the information stored in said memory (150).

19. Optical disc drive apparatus (1) according to claim 16, wherein the control circuit (90) further comprises a memory (150) containing information on a relationship between the focal offset signal (S_{FO}) and lens shift (LS);
wherein the control circuit (90) receives an input signal (S_{R}) containing information representing the actual lens shift (LS);
wherein the second processing block (140) is designed for processing said signal (S_{R}) to calculate the actual lens shift (LS), and to calculate the focal offset signal (S_{FO}) from said actual lens shift (LS) on the basis of the information stored in said memory (150).

20. Optical disc drive apparatus (1) according to claim 19, wherein the memory (150) further contains information on a relationship between the lens shift (LS) and at least one measuring signal (Px;Py) derivable from the detector output signal (S_{R});
wherein the second processing block (140) is designed to derive said at least one measuring signal (Px;Py) from the detector output signal (S_{R}), and to calculate the actual lens shift (LS) from said at least one measuring signal (Px;Py) on the basis of the information stored in said memory (150).
